(19) United States
(12) Patent Application Publication
(10) Pub. No.: US 2009/0010647 A1
(43) Pub. Date: Jan. 8, 2009

(54) METHOD AND APPARATUS FOR ROUTING COMMUNICATIONS IN A MESH NETWORK

(76) Inventors: David W. Jenkins, North Aurora, IL (US); Kenneth M. Fisher, Aurora, IL (US); Julia Y. Larokova, Naperville, IL (US)

Correspondence Address: DAVIS & ASSOCIATES, P.O. BOX 1093, DRIPPING SPRINGS, TX, 78620, US

(21) Appl. No.: 11/774,129

(22) Filed: Jul. 6, 2007

(51) Int. Cl. H04J 14/00; H04B 10/00

(52) U.S. Cl. 398/57; 398/147

(57) ABSTRACT

A method includes subdividing a mesh having a plurality of interconnected nodes into a plurality of regions. Each region has an associated primary node. A pre-determined path segment is defined between at least two primary nodes. A primary path between at least two primary nodes is selected utilizing only primary nodes and the pre-determined path segments.

### TECHNICAL FIELD

This invention relates to the field of communications. In particular, this invention is drawn to methods and apparatus for routing network communications.

### BACKGROUND

Optical communications networks are used to transport large amounts of voice and data communications using optical signals carried by fiber optic cables. Wave-division multiplexing (WDM) can be utilized to transmit multiple channels of optical information through the same optical fiber. Each channel is assigned a different optical wavelength.

Frequency or mode dependence of the phase velocity of an optical signal in the fiber is referred to as dispersion. Various properties of the optical fiber can contribute to dispersion. Perhaps the most significant type of dispersion is the frequency dependence of the phase velocity. Different spectral components of an optical signal propagate at different velocities through the optical fiber. This results in broadening of optical pulses. The effect of dispersion increases with the distance traveled through the optical fiber. To combat the effects of dispersion, compensators can be placed at various points in the network.

The total amount of dispersion increases with the distance traveled through optical fibers. The channels of an optical fiber link may correspond to mere segments of paths of varying lengths between source and destination nodes thus complicating decisions regarding number, placement, and sizing of compensators. Dispersion compensators can affect each wavelength carried by the optical fiber. Overcompensation is just as problematic as undercompensation

Networks allow for the possibility of forwarding communications around problematic nodes or links. The ability to switch to a different link drastically increases the possible number of paths that can be taken between two network nodes. A determination of the number, amount, and placement of optical compensation becomes computationally impractical due to the large number of possible paths.

### SUMMARY

In one embodiment, a method includes subdividing a mesh comprising a plurality of interconnected nodes into a plurality of regions. Each region has an associated primary node. A pre-determined path segment is defined between at least two primary nodes. A primary path is selected between at least two primary nodes utilizing only primary nodes and the pre-determined path segments.

In one embodiment, an apparatus includes a processor coupled to a plurality of interconnected nodes defining a mesh. The processor subdivides the mesh into a plurality of regions. The processor selects an associated primary node for each region and identifies a pre-determined path segment between at least two primary nodes. The processor selects a primary path between at least two primary nodes utilizing only primary nodes and the pre-determined path segments.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of an optical network.

FIG. 2 illustrates a few of the possible routes between nodes at opposing corners of a regular grid.

FIG. 3 illustrates one embodiment of a method of pruning the possible paths when configuring an optical network.

FIG. 4 illustrates application of the method of FIG. 3 to the mesh of FIG. 1.

FIG. 5 illustrates one embodiment of a method of applying mesh dispersion compensation.

### DETAILED DESCRIPTION

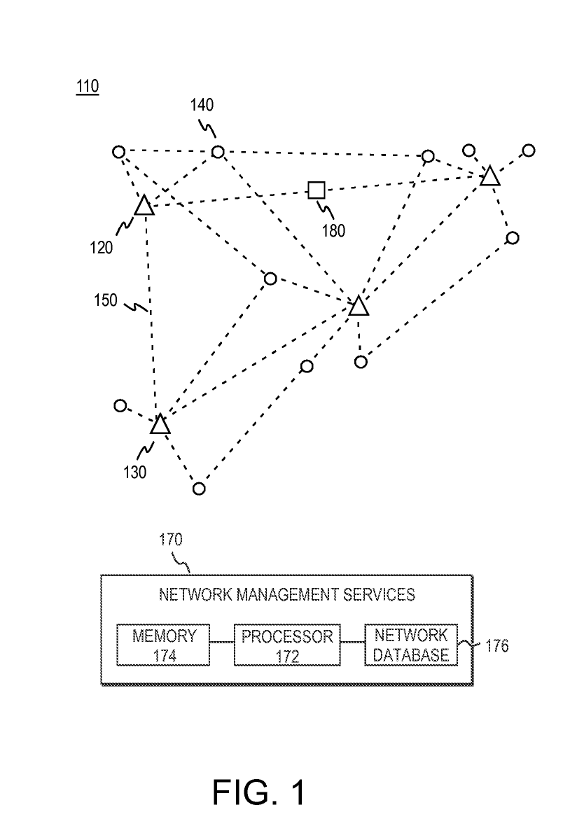

FIG. 1 illustrates one embodiment of a mesh network 110 including a plurality of nodes 120, 130, 140. The interconnections 150 between nodes may be referred to as path segments or links. There are various types of nodes including routers, switches, amplifiers, and repeaters. For example, nodes 120 and 130 may provide hub functionality. A path is the route data travels from a source node to its targeted destination node along path segments and through any intervening nodes. The path may alternately be referred to as the route.

The illustrated embodiment illustrates possible path segments 150 that may be utilized to communicate between nodes. Nodes 120, 130 are adjacent nodes because there is no intervening node on path segment 150 between nodes 120, 130. Nodes 130, 140 are non-adjacent nodes because there is no path that couples 130, 140 without passing through another node. There may be a different number of possible paths for different source-destination node pairs. Nonetheless, there still can be a large number of possible routes between any two nodes. From a data flow standpoint, nodes may operate as source nodes, destination nodes, or intermediate nodes or any combination of these simultaneously for different paths.

In optical communications networks, the links are optical fibers. Optical fiber communications experience degradation due to various physical properties of the optical fiber. Other network elements may also contribute to the degradation of the signal. This degradation tends to limit the distance over which information can be effectively communicated. For example, the propagation velocity of an optical signal within an optical fiber is frequency dependent. Due to the spectral content of a pulse, the optical pulses tend to become spread out or broadened through a phenomenon referred to as material or chromatic dispersion.

Various compensation techniques have been developed to mitigate the effects of dispersion. Dispersion compensation modules (DCMs) may be used to compensate for unwanted material dispersion. The dispersion compensation function may alternately be built into one or more of the nodes. Compensation may take place in either the electrical or optical domains.

One approach for optical domain dispersion compensation utilizes lengths of dispersion compensation fiber (DCF). DCF has a dispersion profile generally opposite that of the network transport fiber. The transport fiber and DCF both disperse the optical signal, however, one fiber has a positive slope dispersion profile and the other fiber has a negative slope dispersion profile.

The amount of compensation applied is determined by the length and physical properties of the fiber. The amount of compensation is controlled mechanically by varying the length and type of dispersion compensation fiber. DCF generally compensates large bandwidths of frequencies and can compensate many channels simultaneously.

Another approach for optical domain dispersion compensation utilizes electronically controlled dispersion compensation. Examples of such devices include deformable micro-electromechanical systems (MEMS), fiber Bragg gratings, tunable etalon filters, phase shifting planar waveguides, and tunable diffraction gratings. These devices may be controlled electronically to vary the amount of compensation provided, however, the range of frequencies over which compensation can be introduced is limited. Typically only a single or perhaps a few channels may be compensated in such fashion.

Compensation in the electrical domain inherently requires an optical-to-electrical conversion. In the electrical domain, the signals can be analyzed to identify and clean-up pulses. Electrical domain compensation may be less desirable due to the requirement of an optical-to-electrical conversion and a possible electrical-to-optical conversion if further optical transport is required. Electrical domain compensation is controlled electronically.

One consideration when planning an optical network is the number, location, and amount of compensation to be applied in order to adequately compensate for dispersion. Determining the number and optimal placement of these dispersion compensation modules can be an exercise in computational complexity.

A number of paths of varying lengths may share the same optical fiber link. Given that the amount of dispersion is cumulative with the distance traveled, the designer must be careful to ensure that adequate compensation is provided without overcompensating or undercompensating any path. Although the ability of a node to select an alternate path in order to forward around problematic nodes or links is desirable for network robustness, such capabilities greatly complicate the determination of an appropriate compensation solution for the network.

Connectivity of adjacent nodes is defined by a path segment. A primary communication path between two nodes might utilize a particular combination of path segments. In the event of a problem with a particular path segment, an alternate path utilizing a different combination of path segments may be utilized.

The number of possible paths defined by various combinations of path segments creates an overwhelmingly complex computational problem for even a small number of nodes when trying to determine optimal primary communication paths and the location and amounts of compensation to apply. A path segment between adjacent nodes may be utilized as a path segment for paths connecting various other node-pairs.

Consideration must be given to the possibilities of re-routing. The purpose of the mesh is to ensure more than one path between nodes. Re-routing effectively selects another path between nodes by selecting a different combination of path segments. The network should be designed to ensure that each potential path has sufficient compensation but is not overcompensated. The number of possible paths is large for even a relatively small mesh.

An apparatus providing network management services 170 includes a database 176 identifying the physical configuration of the network such as location of the nodes and interconnections between nodes. The database may also retain information regarding the properties of the optical fiber links. Processor 172 retrieves program code from memory 174 for execution. The processor is capable of querying or updating the database 176 in accordance with instructions stored in memory 174. Knowledge of the location of nodes and interconnections between them permits analysis for determining the location and amount of dispersion compensation. A large number of possible paths and the possibility of path switching complicates determination of the location of compensators.

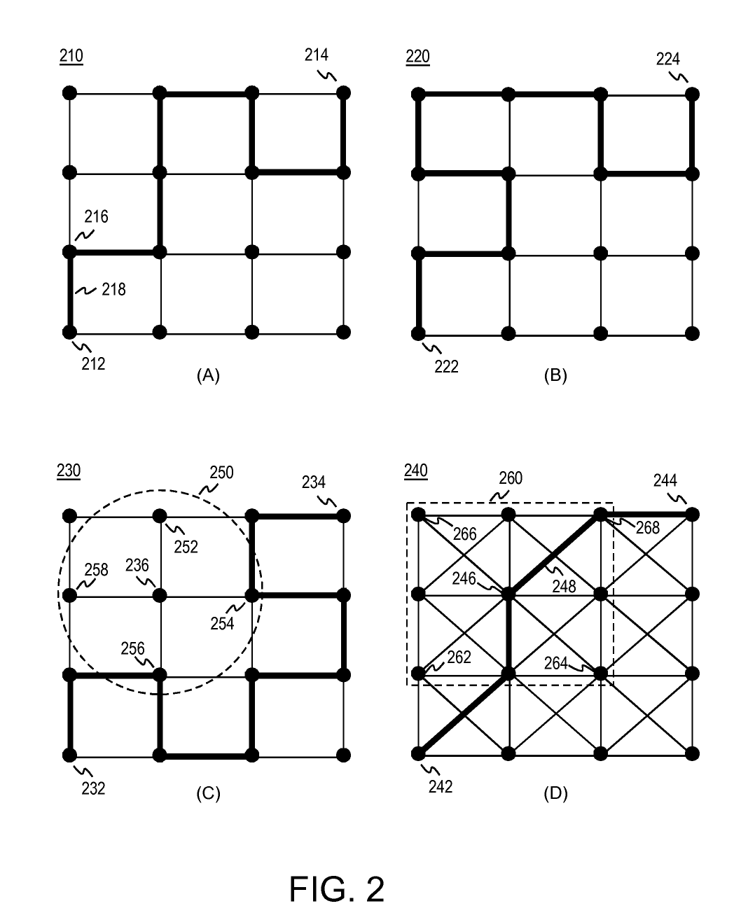

FIG. 2 illustrates a few of the possible routes between nodes at opposing corners of a regular grid. The illustrated grids provide an opportunity for mathematical modeling and analysis, however, networks generally do not follow such a regular grid in practice nor can they readily be represented as a rectangular grill even if actual relative geographic location is ignored.

Each grid 210 includes a plurality of nodes 212, 214, 216. Nodes may be adjacent or non-adjacent relative to each other. Nodes are adjacent if they can be connected by a path segment that does not include or pass through another node. Nodes 212 and 216, for example, are adjacent nodes connected by path 218. Adjacency is determined by connectivity not by proximity.

When the route possibilities at each node is constrained to “up, down, left, or right” (i.e., excluding diagonal moves) as illustrated in grids 210, 220, and 230, the routing problem is sometimes referred to as a “self-avoiding walk” (SAW). A SAW maps a route from one node 212 to another node 214 by stepping from adjacent node to adjacent node without re-visiting any node already visited.

Grids 210, 220, and 230 illustrate three different routes from a node (212, 222, 232) at one corner to a node (214, 224, 234) at an opposing corner. In these examples, adjacent nodes were constrained to exclude those that could be connected via diagonal path segments. Referring to grid 230, for example, the nodes adjacent to node 236 are constrained to the other nodes within region 250 (i.e., including 252, 254, 256, and 258). For just a 5×5 regular grid, there are 1,262,826 possible paths to consider between node 232 and 234. The path segments utilized may also be shared by other paths between other nodes.

Referring to grid 240, for example, the nodes adjacent to node 246 include all the other nodes within region 260 thus expanding adjacency to include nodes 262, 264, 266, and 268. The number of possible paths is greater than the case when adjacency is constrained as illustrated with grids 210, 220, and 230.

Grids 210-240 illustrate paths from one node to another node. However, there are other node-node paths that may share one or more of the path segments utilized for the corner-to-corner examples. This complicates the process of determining how much compensation to apply and where. Compensation applied in the appropriate amount for one path may inadvertently result in overcompensation for a different path. Also, one must consider the appropriate compensation when switching to alternate paths between nodes. Any compensation for the alternate path must be adequate for that path without resulting in overcompensation or undercompensation for the alternate path or any other path.

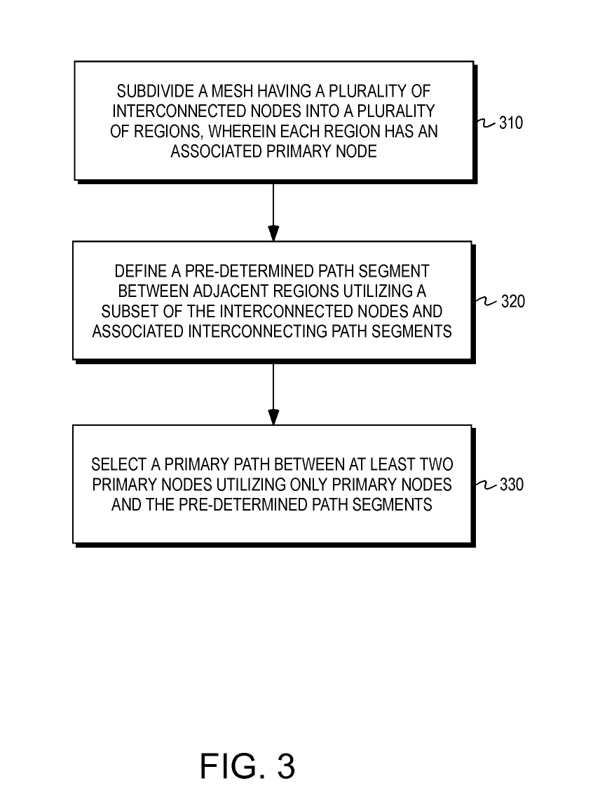

FIG. 3 illustrates one embodiment of a process of pruning the possible number of paths. A hierarchy of nodes is established (e.g., primary and other) to enable reducing the number of potential paths to consider when selecting paths through the mesh of interconnected nodes.

In step 310, a mesh having a plurality of interconnected nodes is subdivided into a plurality of regions. Each region has an associated primary node. In step 320, pre-determined path segments between the primary nodes of adjacent regions are defined. These pre-determined path segments utilize a subset of the interconnected nodes and associated interconnecting path segments located only within the adjacent regions. A primary path between at least two primary nodes utilizing only primary nodes and the pre-determined path segments is identified in step 330. In one embodiment, the pre-determined paths utilize subsets of the interconnected nodes and associated interconnecting path segments located only within the adjacent regions.

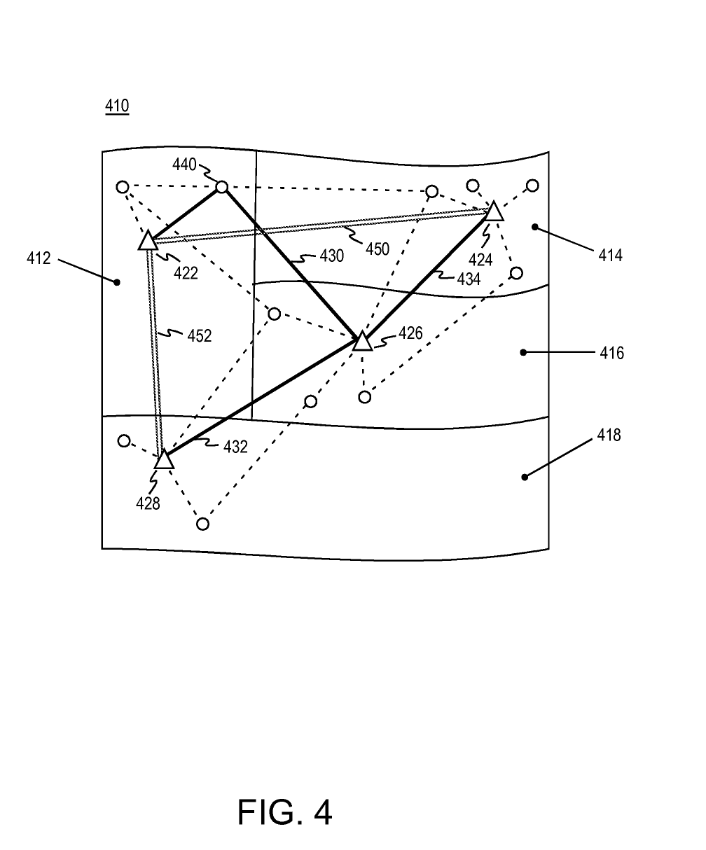

FIG. 4 illustrates application of the method of FIG. 3 to the mesh of FIG. 1. Mesh 410 is subdivided into a plurality of regions 412, 414, 416, 418. An associated primary node 422, 424, 426, and 428 is identified for each region 412, 414, 416, 418, respectively. Pre-determined path segments (e.g., 430, 432, 434, 450, and 452) between primary nodes of adjacent regions are defined. Primary paths between the primary nodes are selected using a subset of the pre-determined path segments.

Pre-determined path segment 430 is selected as the primary path between primary nodes 422 and 426. Pre-determined path segment 432 is selected as the primary path between primary nodes 426 and 428. Pre-determined path segment 434 is selected as the primary path between primary nodes 426 and 424. Pre-determined path segments 450 and 452 are not selected for any primary paths.

Although the process of determining paths between primary nodes can determine which pre-determined path segments to use, the process of determining paths does not redefine the nodes that form the pre-determined path segments. Pre-determined path segment 430, for example, connects primary nodes 422 and 426 through node 440. The determination of primary paths may select whether to utilize pre-determined path segment 430 but does not determine the elements that form the pre-determined path segment 430.

In one embodiment, the nodes selected to be primary nodes are selected based upon functionality. For example, in one embodiment, primary nodes 422, 424, 426, and 428 are hubs.

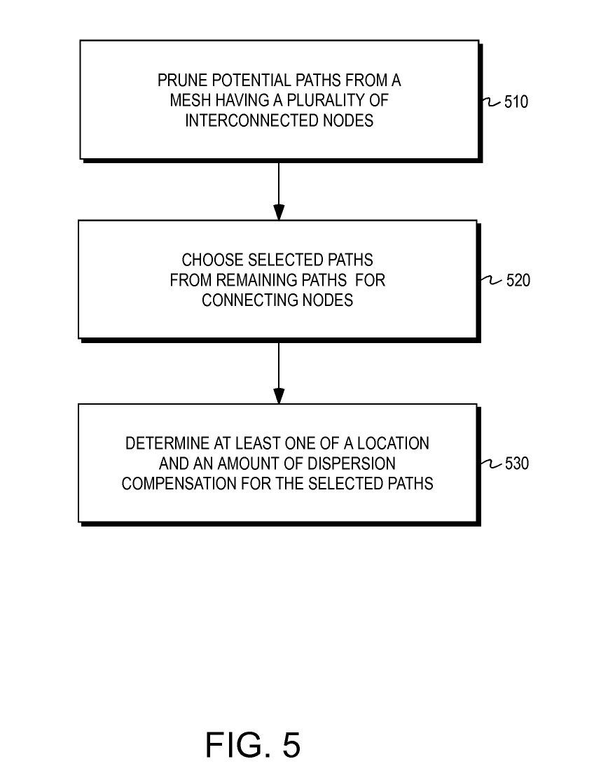

FIG. 5 illustrates one embodiment of a method of determining a location and amount of dispersion compensation for a mesh. In step 510, potential paths between a plurality of interconnected nodes are pruned. The pruning of potential paths does not eliminate any actual paths. The purpose of pruning is to reduce the computational load on the processors required to otherwise select paths. The process of FIG. 3 may be applied to prune potential paths.

After pruning, selected paths are chosen from those remaining paths for connecting nodes in step 520. Traditional tools may then be used to place dispersion compensators. In step 530, a location and amount of dispersion compensation for the selected paths are determined.

The method of FIG. 5 may be performed at least in part by a processor such as processor 172 of FIG. 1. The type, location, and reachability or connectedness of the nodes may be defined by database 176 or described by data structures stored in memory 174. The processor is thus provided with a map of a plurality of interconnected nodes defining a mesh.

Pruning of potential paths may be guided by heuristics. For example, with respect to subdividing the mesh into a plurality of regions, a predetermined grid size may be established for regions. Alternatively, the regions may be pre-determined, for example, by geographic boundaries. Every region that is to be connected must include at least one node that can become a primary node. The processor subdivides the mesh into a plurality of regions, each region having an associated primary node of the plurality of interconnected nodes. This subdivision is accomplished logically using the map.

The processor identifies a selectable pre-determined path segment between at least two primary nodes. The processor may be guided to select path segments with particular characteristics such as path length, reliability, bandwidth, load, economic cost, delay, and channel noise as the selectable pre-determined path segments. Although path length is often expressed as the number of “hops”, the path length may alternatively be expressed as length for purposes of estimating the amount of dispersion that will be incurred. After the pre-determined path segments are identified for the mesh, the processor may identify a primary path between at least two primary nodes utilizing only primary nodes and the pre-determined path segments.

Once the paths have been established for the network, processor 172 may proceed to determine a location and amount of dispersion compensation to be applied to the mesh network using traditional techniques. The location or amount of compensation may be pre-determined. For example, if dispersion compensators are already in a fixed location relative to some of the nodes, then the processor only needs to identify the amount of dispersion compensation to be applied by the one or more dispersion compensators.

Alternatively, the amount of compensation may be limited to discrete amounts within a range of values. Thus the processor is further constrained by limitations on the amount of possible dispersion compensation while having greater flexibility with respect to where the dispersion compensators are located.

In some embodiments, the mesh network may be equipped with electronically adjustable dispersion compensators that compensate in one of the optical or electrical domains. In such case, the mesh network may be communicatively coupled to processor 172 to enable programmatic control of the electronically adjustable dispersion compensator. With respect to FIG. 1, at least some of the nodes 130 incorporate an adjustable dispersion compensator in one embodiment. Alternatively or in addition to any such nodes, one or more fixed or adjustable dispersion compensators 180 may be placed on path segments.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method comprising:
subdividing a mesh comprising a plurality of interconnected nodes into a plurality of regions, wherein each region has an associated primary node;
defining a pre-determined path segment between at least two primary nodes; and
selecting a primary path between at least two primary nodes utilizing only primary nodes and the pre-determined path segments.

2. The method of claim 1 wherein the pre-determined path segment is defined for all adjacent primary nodes.

3. The method of claim 1 further comprising:
applying dispersion compensation along the primary path.

4. The method of claim 3 further comprising:
applying the dispersion compensation to at least one of the pre-determined path segment and one of the primary nodes.

5. The method of claim 1 wherein the pre-determined path couples primary nodes of adjacent regions of the subdivided mesh, wherein the pre-determined path utilizes subsets of the interconnected nodes and associated interconnecting path segments located only within the adjacent regions.

6. The method of claim 1 wherein the primary nodes are hubs.

7. The method of claim 1 wherein the primary path is an optical path.

8. An apparatus comprising:
a processor coupled to receive a map of a plurality of interconnected nodes defining a mesh, wherein the processor subdivides the mesh into a plurality of regions, each region having an associated primary node of the plurality of interconnected nodes, wherein the processor identifies a selectable pre-determined path segment between at least two primary nodes, wherein the processor selects a primary path between at least two primary nodes utilizing only primary nodes and selectable pre-determined path segments.

9. The apparatus of claim 8 wherein the pre-determined path segment is defined for all adjacent primary nodes.

10. The apparatus of claim 8 further comprising:
a dispersion compensator disposed in the primary path.

11. The apparatus of claim 8 further comprising:
a dispersion compensator disposed in the pre-determined path segment.

12. The apparatus of claim 8 wherein the pre-determined path couples primary nodes of adjacent regions of the subdivided mesh, wherein the pre-determined path utilizes subsets of the interconnected nodes and associated interconnecting path segments located only within the adjacent regions.

13. The apparatus of claim 8 wherein the primary nodes are hubs.

14. The apparatus of claim 8 wherein the primary path is an optical path.

15. The apparatus of claim 8 wherein the primary path carries a wave division multiplexed optical signal.
